(19) United States
(12) Patent Application Publication
(10) Pub. No.: US 2006/0092635 A1
(43) Pub. Date: May 4, 2006

(54) Rope light arrangement for lamps and pedestals and packaging therefore

(76) Inventors: Lee Schaak, New York, NY (US); Jeff Fu, Taipei (TW)

Correspondence Address: DARBY & DARBY P.C., P. O. BOX 5257, NEW YORK, NY, 10150-5257, US

(21) Appl. No.: 10/978,013

(22) Filed: Oct. 29, 2004

(51) Int. Cl. F21V 1/00

(52) U.S. Cl. 362/236; 362/228; 362/250

(57) ABSTRACT

The present invention relates to arrangements of rope lights in lamps and pedestals, and packaging therefor. The lamp assembly includes an upper assembly for receiving a light bulb and a lamp shade, a base and at least one coupler having a through hole. A lower support body having a bottom opening and a top opening is located between the coupler and the base and an upper support body having a bottom opening and a top opening is located between the upper assembly and the coupler. Both the upper and lower bodies each having a conduit for receiving a rope light which is disposed within the upper and lower support bodies and extends therebetween within the through hole of the at least one coupler. A first connector is adapted to connect the upper assembly to the top opening of upper body and a second connector adapted to connect the base to the bottom opening of the lower body.

### FIELD OF THE INVENTION

The present invention relates to arrangements of rope lights in lamps and pedestals, and packaging therefor.

### BACKGROUND OF THE INVENTION

Typically, a floor lamp must have a height sufficient to elevate a bulb in order to be effective in lighting a room. This height, together with the bulkiness of a lamp shade and a base require a bulky container for packaging the lamp and results in a high shipping and handling cost from the manufacturer to the retailer and in a high storage cost to the retailer. These costs of the product are ultimately passed onto the consumer. One prior art method for reducing the bulkiness of floor lamp packages has been to provide a floor lamp which is packaged in a disassembled state and which can be assembled by the consumer. By making the composite floor lamp package more compact, there is a savings in the shipping and handling cost. Prior art packaging methods for floor lamps include partitioning the lamp into sections and securing each individual section in form fitting packaging material such as styrofoam or cardboard. In such floor lamps, the support poles typically house a power cord for supplying AC power to the lamp, which once assembled, is hidden within the support pole. Power cords are flexible and sufficient slack is typically provided such that the lamp can be broken down, packaged and reassembled without damage to the cord housed within.

Conventional packaging methods are not appropriate for floor lamps that include an internal rope light because they do not take into account the differences in the stiffness and kink potential between a power cord and a rope light. For example, if a rope light is to behave within the support pole of an elongated lamp, there is a need to secure and protect the light rope core when the lamp is packaged to prevent damage to one or more of the components of the rope light. Such damage occurs, for example, from arcing the rope light between two disassembled support poles. The poles cannot be packaged close together or else the rope light core will arc past an acceptable arc length and can be damaged.

Secondly, once assembled, the rope light which typically has slack between pole segments to permit packaging in pieces results in free movements arrangements of the rope light within the support pole. This can result in a jumbled, unattractive appearance. Conventional rope light floor lamps have not taken into account the need to support the rope light under tension such that it is held taught within the assembled support pole, giving the rope light an approximately linear, column like appearance. The present invention solves these and other difficulties experienced with prior art rope lit floor lamps.

### SUMMARY OF THE INVENTION

In accordance with one aspect of the invention, a floor lamp including a upper assembly for receiving a light bulb and a lamp shade, a base and at least one coupler having a through hole. A lower support body having a bottom opening and a top opening is located between the coupler and the base, and an upper support body having a bottom opening and a top opening is located between the upper assembly and the coupler. Both the upper and lower bodies each having a conduit for receiving a rope light which is disposed within the upper and lower support bodies and extends therebetween within the through hole of the at least one coupler. A first connector is adapted to connect the upper assembly to the top opening of upper body and a second connector adapted to connect the base to the bottom opening of the lower body.

In accordance with another aspect of the invention, the floor lamp can further include at least one gasket seated relative to the upper and lower bodies and to engage the a rope light, the gasket having an opening to receive the at least one rope light therethrough.

According to another aspect of the present invention, a floor lamp package is provided including a pre-form having one or more cavities sized to seat at least two lamp pole segments and a portion of a rope light extending from within and between the at least two lamp pole segments such that a minimum arc radius of the rope light is sufficiently large to prevent kinking in the rope light. A package surrounds the preform and the floor lamp package encloses a disassembled floor lamp including at least two lamp pole segments each having an axial channel therethrough and a rope light disposed within the axial channel and extending from at least one end of each of the lamp pole segments.

According to yet a further aspect of the invention, a rope light can be disposed about an outer perimeter of the base, the upper assembly, or both, such that an arc radius of the second rope light is greater than a radial distance to the outer perimeter, wherein both the arc radius and the radial distance are taken from a common point on the base, upper assembly, or both, as the case may be.

Further embodiments incorporating the above rope light arrangements are disclosed for use in conventional lamps, i.e., a desk lamp and a table.

These and further aspects, features and advantages of the present invention will become more apparent from the following description when taken in connection with the accompanying drawings which show, for purposes of illustration only, a preferred embodiment of the present invention.

### BRIEF DESCRIPTION OF THE DRAWINGS

FIG. 1 is an perspective view of a floor lamp which includes a rope light according to an embodiment of the present invention;

FIG. 2 is an exploded view of the floor lamp of FIG. 1, showing individual components of the lamp;

FIG. 3 is a fragmented perspective view of a sectional cylindrical tube enclosing a rope light which forms part of the construction of the main body of the lamp assembly of FIG. 1;

FIG. 4 is a plan view of the cylindrical tube about the line A-A in FIG. 3;

FIG. 5 is a perspective view of a coupler body which is used for connecting the sectional tubes to form the main body of the lamp of FIG. 1;

FIG. 6 is a perspective view of the cap portion of the upper assembly of the lamp of FIG. 1;

FIG. 7 is a perspective view of a coupler body which is used for connecting the sectional tubes to form the main body according to a second embodiment of the present invention;

FIG. 8 is a fragmented perspective view of a sectional cylindrical tube enclosing a rope light and engaging the coupler body of FIG. 7;

FIG. 9 is a broken away top perspective view of a composite floor lamp package which shows the sectional hollow tubes packed in a box which is specifically designed for the floor lamp of FIG. 1;

FIG. 10 is a perspective view of a lamp which includes a rope light according to a third embodiment of the present invention; and

FIG. 11 is a perspective view of a table which includes a rope light according to a forth embodiment of the present invention.

### DETAILED DESCRIPTION OF CERTAIN EMBODIMENTS

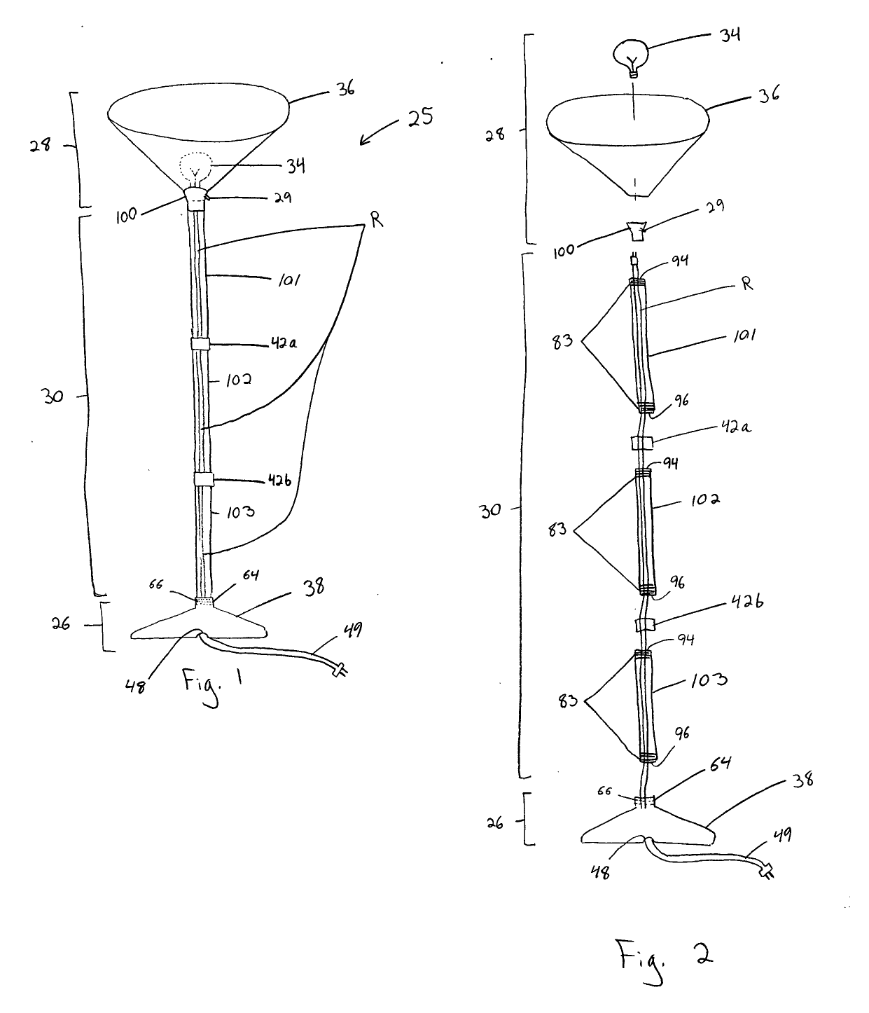

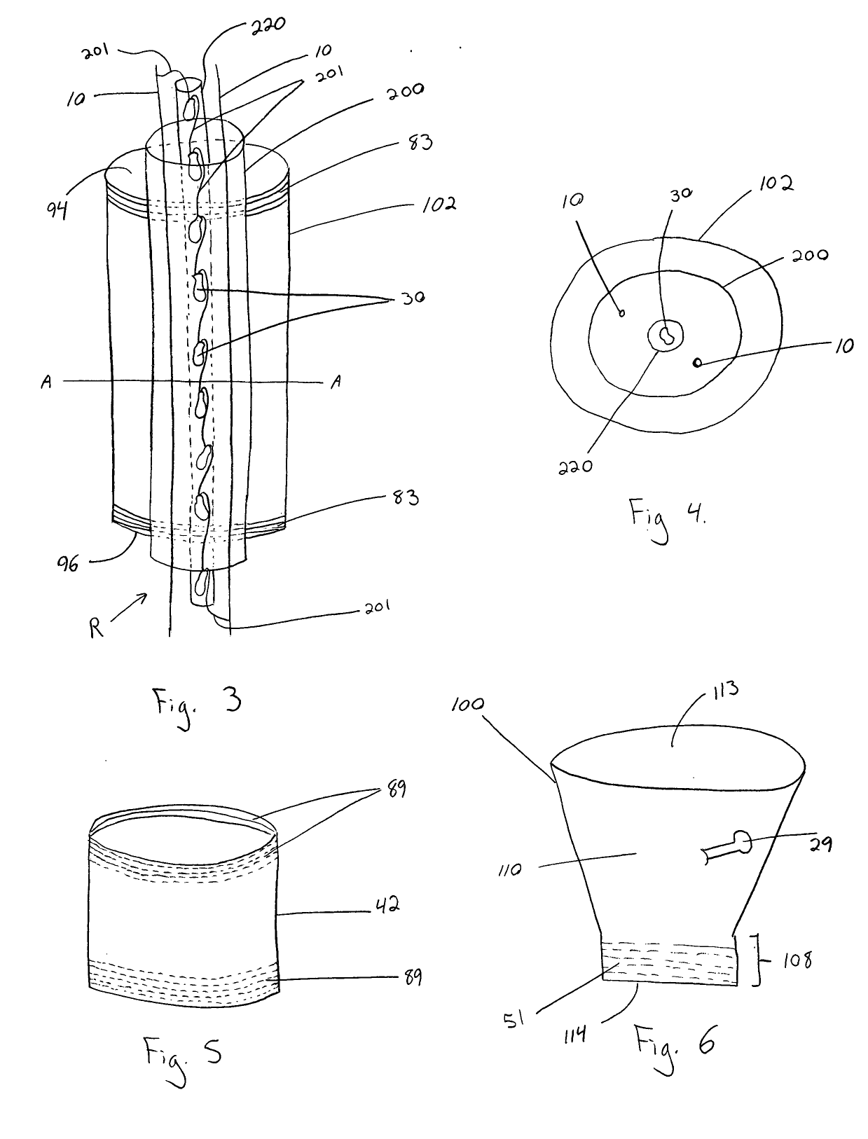

Referring to FIGS. 1 and 2, the floor lamp of the present invention is generally indicated by the reference numeral 25 and comprises a bottom assembly 26, a upper assembly 28 and an elongated main body 30. Main body 30 comprises sectional hollow tubes, 101, 102 and 103, respectively, which are located between the bottom assembly 26 and the upper assembly 28. The upper assembly 28 includes a light fixture (not shown) which is preferably fixed to the top of the upper assembly 28 for receiving a conventional light bulb 34 and for supporting a lamp shade 36. The lamp shade 36 preferably comprises a frusto-conical outer wall which has a large diameter opening at the top of the shade and a small diameter opening at the bottom of the shade. In the illustrated embodiment of FIG. 1, the floor lamp arrangement is generally known as a torchiere design.

The bottom assembly 26 includes a base 38 comprising a semi-circular port 48 for receiving a power cord 49. The base 38 preferably has a disk-shaped footprint or perimeter, an upwardly extending cylindrical upper portion 64 and a conical intermediate portion which is located between the disk-shaped footprint and the upwardly extending cylindrical portion 64. The base 38 can have a central vertical orifice which typically is co-axial with the main body 30 for receiving a rope light R. The upwardly extending projection 64, if provided, has an inner diameter which is substantially equal to the outer diameter of sectional tube 103 and is threaded 66 for receiving opposing outer threads 83 of a bottom end of tube 103 providing a tight fit. Alternatively, the main body can be provided on a base constructed without the projection 64. In either case, the base typically includes a weight (not shown) to impact stability to the lamp 25.

Referring particularly to FIGS. 1-2 and 5, first and second couplers 42a, 42b have a through hole and comprise a cylindrical mid-portion with an open upper and lower end. For clarity, couplers 42a and 42b will be described generally below with reference to coupler 42 shown in FIG. 5, as they may be identical in construction. The inner diameter of coupler 42 is substantially equal to the outer diameter of the sectional tubes 101, 102 and 103. The hollow interior of the coupler has threads 89 for receiving opposing threaded end portions 83 of sectional poles 101, 102 and 103 and providing a tight fit as show in FIG. 1.

Referring to FIGS. 2 and 3, the elongated main body 30 is partitioned into three preferably equal cylindrical tubes 101, 102 and 103, each of which has a top opening 94 and a bottom opening 96. The main body 30 is positioned on the bottom assembly 26 so that the bottom opening 96 of tube 103 extends into projection 64 of base 38. The inner diameter of the projection 64 can approximate the outer diameter of the main body 30 so that the threads 83 and 66 provide a tight frictional fit between the projection 64 and the tube 103. The first and second couplers 42a, 42b and the sectional tubes 101, 102, 103 are preferably made of plastic and the base 26 is preferably made of metal, such as stainless steel. According to alternative arrangements of the present invention, main body 30 can comprise a plurality of cylindrical tubes connected together by couplers 42 and is not restricted to just three tubes 101, 102 and 103 as in the illustrated embodiment.

Referring to FIG. 3, an elongated rope light R includes a plurality of lights 30 that are serially connected to one another by sequentially connecting lead wires 201 of two adjacent lights 30 together to form a bulb string, which is then set in a long core tube 220 to extend in parallel with the core tube 220. Lead wires 201 of a first and a last light 30 in the bulb string are respectively connected to exposed elongate main body conductors 10, and more preferably two main body conductors to form a close circuit on the rope light R.

Each exposed main body conductors 10 is positioned to extend external to core tube 220 and substantially parallel the entire length of the rope light R. The string of serial connected lights 30 is positioned to extend substantially the entire length of the rope light R and also positioned parallel to the plurality of main body conductors 10. Each of the plurality of lights 30 are preferably light emitting diode lamps and may also be provided in or driven so as to display a plurality of colors.

The rope light subassembly also includes a substantially solid, flexible, translucent, hollow sheath 200. The sheath 200 is preferably a plastic or polymeric material such as polyvinyl chloride (PVC). The serial connected string of lights 30 within core tube 220 is positioned within sheath 200. In the preferred embodiment, the sheath 200 and the core tube 220 are substantially transparent throughout the entire thickness of the rope light R. This advantageously provides enhanced illumination to the elongate rope light R.

The sheath 200 has a continuous annular shape in cross-section and is positioned to encase each of the plurality of exposed main body conductors 10 and the core tube 220 along substantially the entire length of the elongate rope light R so that conducting outer surfaces of the plurality of exposed main body conductors 10, the core tube 220 and the plurality of lights 30 are readily visible to a user through the sheath 200. Sheath 200 can advantageously include formed ridges, ribs, or rough regions which provide the outer sheath 200 with texture for ease of handling and gripping, added strength and enhancing visual appearance for many desired applications. Furthermore, sheath 200 is preferably formed from a single extruded piece of plastic.

Each of the two main body conductors 10 is made of a reflective metallic material. The combination of the illuminated lights 30, the reflective main body conductors 10 and substantially clear sheath 200 and core tube 220 advantageously enhance the illumination of the elongate rope light R.

According to a salient aspect of the present invention, each of the plurality of main body conductors 10 may further include a plurality of strands positioned in a twisted configuration. This twisted configuration also advantageously enhances illumination of each of the elongate rope light R.

Referring particularly to FIG. 6, the upper assembly 28 of the illustrated embodiment preferably includes a cap 100 which functions to support lamp shade 36 and house light switch circuitry and control knob 29. Cap 100 is also configured to act as a coupler for connecting lamp shade 36 to main body 30. The cap 100 can include a cylindrical lower-portion 108 with an threaded internal diameter 51 and a frusto-conical upper projection 110. The cap 100 is generally hollow, has a top opening 113 and a bottom opening 114, and is preferably made of a thermoplastic or metal material.

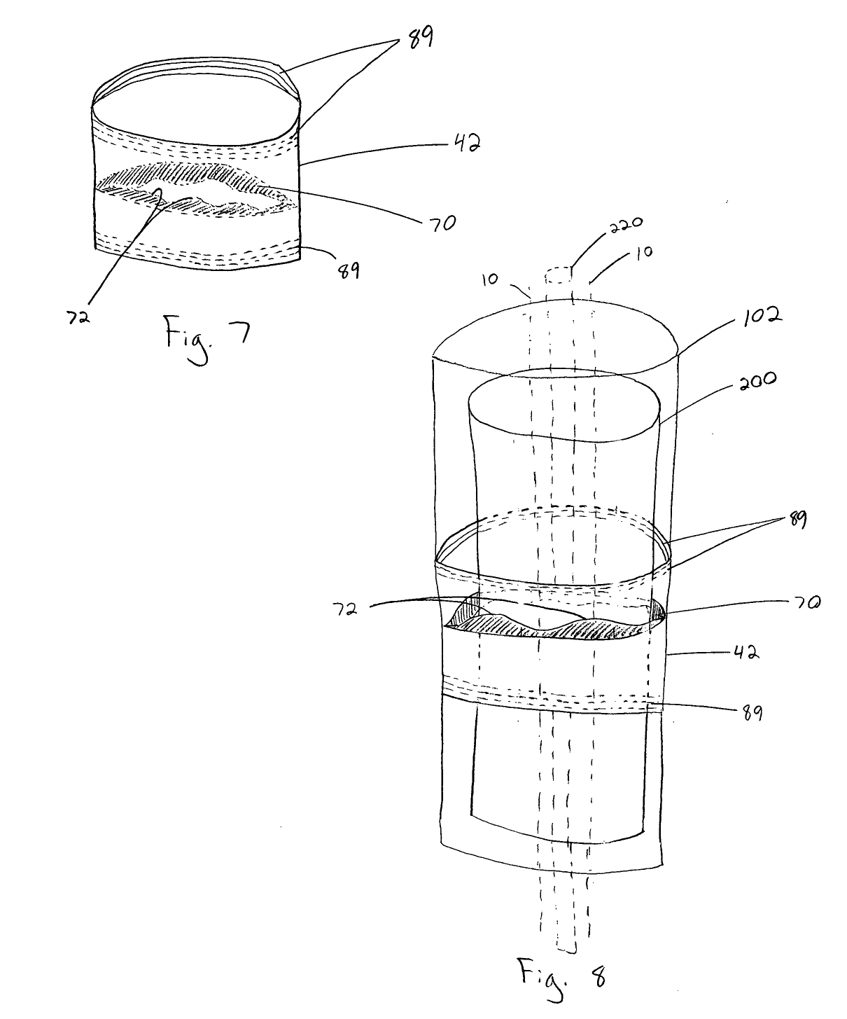

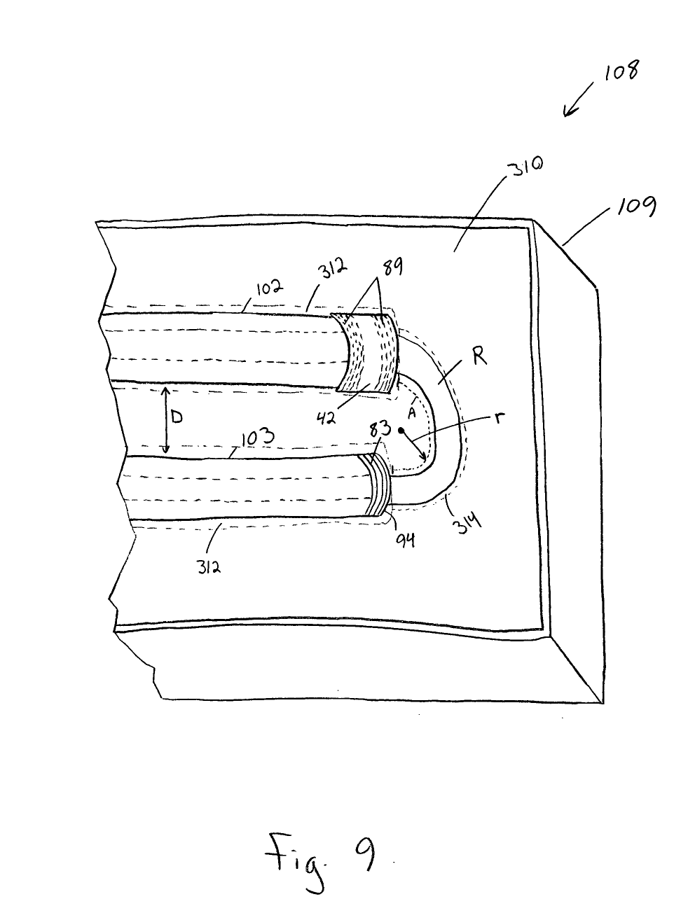

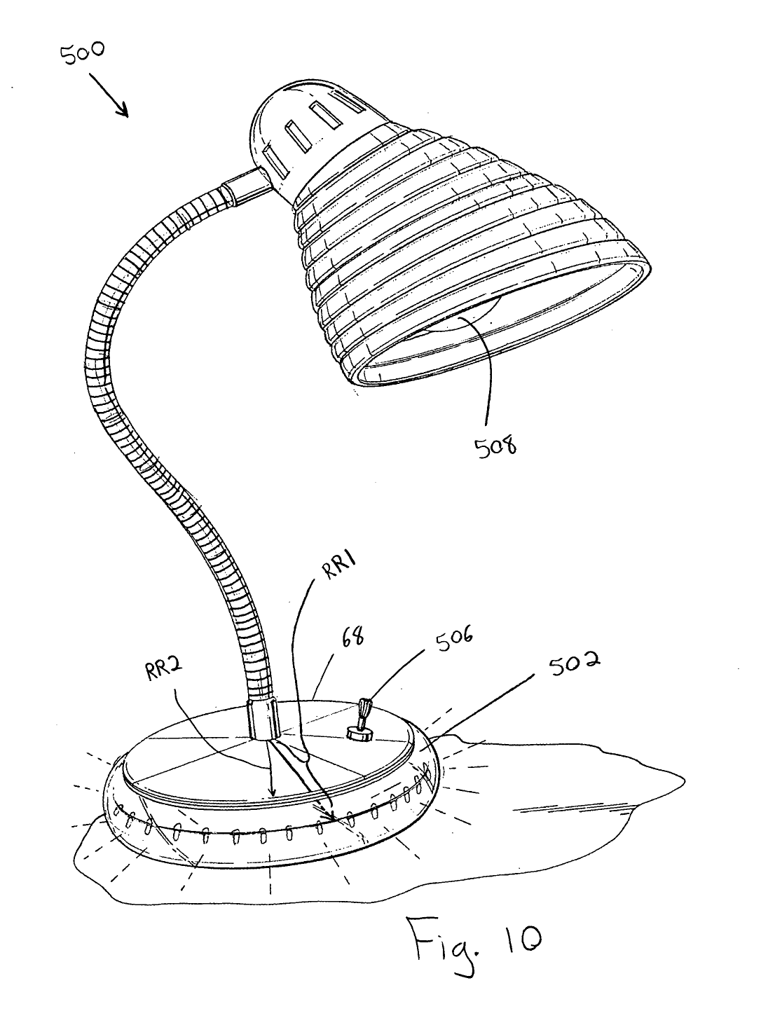

Referring to FIGS. 7 and 8, in accordance with an second embodiment of the present invention a ring shaped gasket 70 is fixedly attached to the inner diameter of coupler 42 for maintaining a tension in the rope light when lamp 25 is in an assembled state, thereby impeding the free movement of rope light R within main body 30. Ring shaped gasket 70 is preferably composed of a flexible material, i.e., rubber, and has a central orifice for frictionally receiving rope light R therethrough. The inner orifice of Gasket 70 may be circular having a diameter essentially equal to the outer diameter of sheath 200. Accordingly, gasket 70 contacts sheath 200 of rope light R impeding its free movement within main body 30 and providing tautness in the rope light which gives the rope light an appearance of lineararity and centeredness within main body 30. As opposed to a radially constant inner orifice, Gasket 70 can be provided with tabs or fingers 72 of varying sizes and dimensions. According to such an arrangement, only the tabs 72 of gasket 70 will engage sheath 200. Depending on the flexibility of the material of which gasket 70 is composed, tabs 72 may bend upward or downward while in contact with the surface of sheath 200 and various different tensions can be maintained on rope light R by varying the shape, size and composition of gasket 70, thereby effecting how tightly gasket 70 grips and restricts sheath 200. However, preferably gasket 70 is configured so as to maintain a sufficient tension on rope light R so as to give the rope light an appearance as though it is centered within sheath 200 along it's entire length. Upon assembly of the lamp 25, a person can pull on the power cord 49 to make the rope light R taut.

Referring to FIG. 9 a partial view of a floor lamp package and shipping container, generally indicated by the reference numeral 108, shows a container 109 for packaging disassembled sectional tubes 101, 102 and 103. The usual top closure flaps are not shown for the sake of clarity. A packaging preform 310 can be configured to sit securely within container 109 and provides a seat that secures the components of floor lamp 25 during transport. Preform 310 is preferably composed of cardboard or Styrofoam and has one or more cavities 312 sized to seat sectional tubes 101-103. Preform 310 also may include a cavity 314 for seating rope light R and maintaining a constant arc length A in the rope light.

According to a preferred embodiment, the sectional tubes are aligned parallel to each other and spaced apart by a distance D such that an arc length A of rope light R does not drop below a predetermined threshold when the pole segments 101-103 are seated in the preform 310. When sectional tubes 102-103 are packaged parallel to each other too closely together such that the distance D between tubes is below a predetermined threshold spacing, the arc length A of rope light will be small which can lead to kinking of the rope light and possible damage to lights 30 and conductors 10 housed within the core tube 220 due to an undesirably low arc radius r. When the sectional tubes are aligned parallel to each other, arc radius r is defined as the radial distance to rope light R (the portion exposed from sectional tubes 102-103) when the tubes are in a disassembled state and is measured from a center point between two ends of the tubes. The distance D to be maintained by the preform 310 between tubes 102 and 103, the arc radius r and the arc length A of the rope light is a function of the material composition and properties of sheath 200. The more resilient a sheath 200, the greater it will be prone to kinking under smaller arc lengths A and radius' r and the greater the need to increase the distance D between adjacent tube section (e.g., tubes 102 and 103). Thus, a preform packaging material having one or more cavities 312 sized to seat at least two lamp pole segments are spaced from one another a distance D such that a minimum arc radius r experienced along an arc length A of the exposed rope light R exceeds a predetermined value for the particular rope light R being used, where the predetermined value of the arc radius r is at least the radius necessary to prevent kinking of sheath 200.

According to an alternative arrangement, section tubes 102 and 103 need not be packaged parallel to each other and can be arranged in any direction with respect to one another which can be necessary or sufficient for packaging. In such an arrangement, cavities 312 of packaging preform 310 may be arranged to converge or diverge. When tubes 102 and 103 sit in such cavities the arc length A and arc radius r of rope light R are functions of not only the material composition and properties of sheath 200, but also of the degree in which tubes 102 are 103 are angularly offset. Cavities 312 of preform 310 are arranged such that a minimum arc radius r experienced along an arc length A of the exposed rope light R exceeds a predetermined value for the particular rope light R being used, where the predetermined value of the arc radius r is at least the radius necessary to prevent kinking of sheath 200.

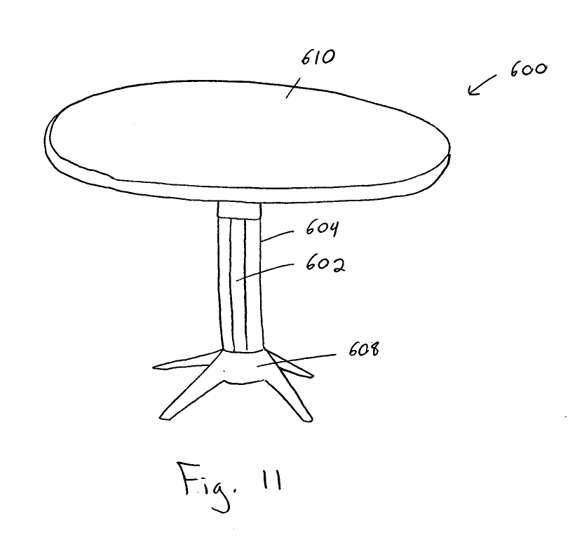

Referring to FIG. 10, a third embodiment of the present invention is shown wherein a base 68 for supporting a lamp assembly 500 includes a circumferential exposed rope light 502 circumscribed about the outer peripheral of the base 68. Rope light 502 is preferably constructed as described above with respect to rope light R, however, as opposed to being placed within a support column extending from the base of a lamp, rope light 502 is positioned to rap around the outer surface of the base 68. Rope light 502 is disposed about an outer perimeter of the base 68 such that an arc radius RR1 of the rope light is greater than a radius RR2 to the outer perimeter of the base from which the rope light encircles. Both the arc radius RR1 and the radial distance RR2 are taken from a common point about the base 68, such as a center point. This rope light arrangement may be used in combination with lamp 25 (FIG. 1) or with any conventional lamp including a base for support. The support body thus can be a tube such as tube 101, or a gooseneck, as understood by those of skill in the art. Additionally, base 68 may include a cavity (not shown) for seating rope light 502 and a switch 506 for controlling the illumination of rope light 502 and light 508.

Referring to FIG. 11, a forth embodiment of the present invention is shown wherein a table 600 includes a rope light 602 disposed within a cylindrical main body 604, a base 608 and a table top 610. Rope light 602 is preferably constructed as described above with respect to rope light R. According to alternative arrangements of the present invention, main body 604 can comprise a plurality of cylindrical tubes connected together by couplers 42 (FIG. 5) and is not restricted to single construction as in the illustrated.

While the invention has been described with reference to several embodiments thereof, the invention is more broadly defined and limited only by the recitations in the claims appended hereto and their legal equivalents.

We claim:

1. A floor lamp comprising:
a upper assembly for receiving a light bulb and a lamp shade;
a base;
at least one coupler having a through hole;
a lower support body having a bottom opening and a top opening, the lower body being located between the coupler and the base;
an upper support body having a bottom opening and a top opening, the upper body being located between the upper assembly and the coupler, the upper and lower bodies each having a conduit for receiving a rope light;
a rope light disposed within the upper and lower support bodies and extending therebetween within the through hole of the at least one coupler;
a first connector adapted to connect the upper assembly to the top opening of upper body; and
a second connector adapted to connect the base to the bottom opening of the lower body.

2. The floor lamp of claim 1, further comprising at least one gasket seated relative to the upper and lower bodies and to engage the a rope light, the gasket having an opening to receive the at least one rope light therethrough.

3. The floor lamp of claim 2 wherein the gasket comprises flexible members for frictionally engaging the rope light and maintaining a tension on the rope light.

4. The floor lamp of claim 1 wherein the rope light comprises an elongate core tube, an outer tube enclosing the core tube and a plurality of bulb strings set in the elongate core tube.

5. The floor lamp of claim 4 wherein each of the plurality of bulb strings includes a plurality of lamps, each of the lamps having two lead wires extended therefrom, any two adjacent lamps in the same one of said bulb strings being serially connected with one of said two lead wires of a preceding lamp to one of said two lead wires of a following lamp.

6. The floor lamp of claim 4 wherein at least one of the elongate core tube and the outer tube are formed from either transparent tubular material or translucent PVC material.

7. A floor lamp package comprising:
a pre-form having one or more cavities sized to seat at least two lamp pole segments and a portion of a rope light extending from within and between the at least two lamp pole segments such that a minimum arc radius of the rope light is sufficiently large to prevent kinking in the rope light;
a disassembled floor lamp comprising:
the at least two lamp pole segments each having an axial channel therethrough; and
a rope light disposed within the axial channel and extending from at least one end of each of the lamp pole segments; and
a package surrounding the preform.

8. A floor lamp comprising:
an upper cylindrical lamp pole segment which has a bottom opening and a top opening;
a lower cylindrical lamp pole segment which has a bottom opening and a top opening;
at least one intermediate cylindrical lamp pole segment which is located between the upper and lower lamp pole segments, the intermediate lamp pole segment having a bottom opening and a top opening, wherein the upper, lower and intermediate lamp pole segments are hollow for receiving at least one rope light and each comprise threaded upper and lower ends;
a lower coupler adapted to couple the upper end of the lower lamp pole segment to the lower end of the central lamp pole segment, the lower coupler having a through hole;
an upper coupler adapted to couple the lower coupler sized to receive the upper end of central lamp pole segment to the bottom end of the lower lamp pole segment, the upper coupler having a through hole;
a rope light disposed within the upper, intermediate and lower lamp pole segments and upper and lower couplers; and
a base connected to the bottom of the lower lamp pole segment.

9. A lamp comprising:
a upper assembly for receiving a light bulb and a lamp shade;
a base;
a rope light disposed about an outer perimeter of the base such that an arc radius of the rope light is greater than a radial distance to the outer perimeter, wherein both the arc radius and the radial distance are taken from a common point on the base; and
a support body having a bottom opening and a top opening, the support body disposed between the upper assembly and the base.

10. A lamp as in claim 9 further comprising a rope light disposed within the support body and extending therein.

11. A table comprising:
a upper assembly;
a base;
a support body having a bottom opening and a top opening, the support body being disposed between the upper assembly and the base; and
a rope light disposed within the support body and extending therein.

12. The table of claim 11 further comprising a second rope light disposed about an outer perimeter of the base such that an arc radius of the second rope light is greater than a radial distance to the outer perimeter, wherein both the arc radius and the radial distance are taken from a common point on the base.
